(19) United States
(12) Patent Application Publication
(10) Pub. No.: US 2015/0351054 A1
(43) Pub. Date: Dec. 3, 2015

(54) METHODS, APPARATUS AND COMPUTER PROGRAMS FOR LIMITING MAXIMUM TRANSMIT POWER OF DEVICES

(71) Applicant: BROADCOM CORPORATION, Irvine, CA (US)

(72) Inventors: Antti Oskari IMMONEN, Helsinki (FI); Jouni Kristian KAUKOVUORI, Vantaa (FI); Tero HENTTONEN, Espoo (FI); Kaisu Maria IISAKKILA, Espoo (FI)

(21) Appl. No.: 14/759,982

(22) PCT Filed: Jan. 9, 2014
(86) PCT No.: PCT/IB2014/058149

§ 371 Date: Jul. 9, 2015

(30) Foreign Application Priority Data
Jan. 11, 2013 (GB) 1300471.8

(51) Int. Cl. H04W 52/36; H04W 72/04

(52) U.S. Cl. CPC H04W 52/367; H04W 72/0473

(57) ABSTRACT

In a method for limiting the maximum transmit power of devices operating in a wireless network, each device supporting one of plural sets of transmit power reduction capabilities, a first message comprising a value of a first parameter associated with a first set of capabilities and a value of a second parameter associated with a second set of capabilities, wherein the second set comprises more capabilities than the first set, is transmitted (400). A signal associated with a device's reception of the first message is received Initiate non-access-related Initiate non-access-related (410). A capability enquiry is transmitted to the device (415). Capability information comprising an indication of whether the device supports the value of the second parameter is received (420). A second message comprising a value of the Transmit capability information Transmit capability information first parameter associated with the second set of capabilities is transmitted upon receiving an indication that the device supports the value of the second parameter (450).

### CROSS REFERENCE TO RELATED APPLICATION

This application claims the benefit under 35 U.S.C. §119 and 37 CFR §1.55 to UK patent application no. 1300471.8, filed on Jan. 11, 2013, the entire content of which is incorporated herein by reference.

### TECHNICAL FIELD

The present invention relates to methods, apparatus and computer programs for limiting the maximum transmit power of devices.

The disclosure herein relates generally to the field of wireless or cellular communications, and particular embodiments relate to methods, devices, and network equipment for efficiently limiting the transmit power of devices operating in the same network but supporting different capability sets (e.g. “releases”) so as to ensure compliance with regulatory and/or operator requirements.

### BACKGROUND

The Third Generation Partnership Project (3GPP) unites six telecommunications standards bodies, known as “Organizational Partners”, and provides their members with a stable environment to produce the highly successful Reports and Specifications that define 3GPP technologies. These technologies are constantly evolving through what have become known as “generations” of commercial cellular/mobile systems. 3GPP also uses a system of parallel “releases” to provide developers with a stable platform for implementation and to allow for the addition of new features required by the market. Each release includes specific functionality and features that are specified in detail by the version of the 3GPP standards associated with that release.

Universal Mobile Telecommunication System (UMTS) is an umbrella term for the third generation (3G) radio technologies developed within 3GPP and initially standardised in Release 4 and Release 99, which preceded Release 4. UMTS includes specifications for both the UMTS Terrestrial Radio Access Network (UTRAN) as well as the Core Network. UTRAN includes the original Wideband CDMA (W-CDMA) radio access technology that uses paired or unpaired 5-MHz channels, initially within frequency bands near 2 GHz but subsequently expanded into other licensed frequency bands. The UTRAN generally includes node-Bs (NBs) and radio network controllers (RNCs). Similarly, GSM/EDGE is an umbrella term for the second-generation (2G) radio technologies initially developed within the European Telecommunication Standards Institute (ETSI) but now further developed and maintained by 3GPP. The GSM/EDGE Radio Access Network (GERAN) generally comprises base stations (BTSs) and base station controllers (BSCs).

Long Term Evolution (LTE) is another umbrella term for so-called fourth-generation (4G) radio access technologies developed within 3GPP and initially standardised in Releases 8 and 9, also known as Evolved UTRAN (E-UTRAN). LTE is accompanied by improvements to non-radio aspects commonly referred to as System Architecture Evolution (SAE), which includes Evolved Packet Core (EPC) network. From the perspective of an end user, one of the most notable features of LTE is much higher data rates than those available in UTRAN or GERAN, which improves the user's experience in many applications including email, audio and video streaming, personal navigation, gaming, etc. Various improvements to LTE are being standardised in 3GPP Releases 10 and 11, including a set of features known as “LTE Advanced.”

Similar to 2G and 3G radio access technologies, LTE is defined according to 3GPP standard to operate in various ranges of frequency spectrum that are licensed for use by respective national governmental authorities, such as the Federal Communications Commission (FCC) in the U.S. One particular LTE band of interest in the U.S. is Band 13, which comprises a range of 777 to 787 MHz for uplink (i.e. device to network) transmission and 746 to 756 MHz for downlink (i.e. network to device) transmission. This band range is also known as “Block C” in regulatory parlance. In the U.S., a 700-MHz Public Safety Narrow Band (PSNB) comprises the range of 799 to 805 MHz for uplink and 769 to 775 MHz for downlink. As such, the spectral distance between the bottom of Band 13 (or Block C) uplink and the PSNB downlink is only 2 MHz. In view of this, the FCC has set an out-of-band spurious emission limit for PSNB of −35 dBm measured in a 6.25-kHz bandwidth, i.e. −35 dBm/6.25 kHz. Currently, a single network operator holds a U.S. nationwide license covering Band 13, and operates an LTE network utilising a single, 10-MHz channel in this spectrum. This operator has established an out-of-band spurious emissions requirement for PSNB (−57 dBm/6.25 kHz) that is even more stringent than the one established by the FCC. This requirement is specified in 3GPP standards as an optional additional power reduction factor for Band 13, and its applicability is indicated to devices by network signalling.

The Canadian regulatory authority, Industry Canada, has adopted a spectrum allocation similar to the FCC's that includes LTE Band 13 (also referred to as C Block) as well as allocations for PSNB services, but with two notable differences. First, C block is sub-divided into two 5-MHz blocks of paired spectrum, with Block C1 comprising a 777 to 782 MHz uplink range paired with a 746 to 751 MHz downlink range, and Block C2 comprises a 782 to 787 MHz uplink and 751 to 756 MHz downlink. Blocks C1 and C2 will be licensed independently. Secondly, the PSNB downlink allocation in Canada extends from 768 to 776 MHz versus 769 to 775 MHz in the US. As such, there is only 1-MHz of unused guard band between Block C1 and PSBN in Canada.

### SUMMARY

According to a first aspect of the present invention, there is provided a method for limiting the maximum transmit power of devices operating in a wireless network, each device supporting one of plural sets of transmit power reduction capabilities, the method comprising: transmitting a first message comprising a value of a first parameter associated with a first set of capabilities and a value of a second parameter associated with a second set of capabilities, wherein the second set comprises more capabilities than the first set; receiving a signal associated with a device's reception of the first message; transmitting a capability enquiry to the device; receiving capability information comprising an indication of whether the device supports the value of the second parameter; and transmitting a second message comprising a value of the first parameter associated with the second set of capabilities upon receiving an indication that the device supports the value of the second parameter.

Some embodiments comprise transmitting a second message comprising a value of the first parameter associated with the first set of capabilities upon receiving an indication that the device does not support the value of the second parameter. Some embodiments comprise determining whether the device supports a value of the second parameter associated with the first set of capabilities, wherein the second message comprises a value of the second parameter associated with the first set of capabilities upon determining the device supports said value. Other embodiments include network equipment (e.g. evolved Node B or a component thereof) embodying one or more of these methods.

According to a second aspect of the present invention, there is provided a method for setting the maximum transmit power of a device operating in a wireless network, the method comprising: receiving a first message comprising a value of a first parameter associated with a first set of capabilities and a value of a second parameter associated with a second set of capabilities, wherein the second set comprises more capabilities than the first set; determining whether the device supports the received value of the second parameter; determining whether the first message comprises a value of the first parameter associated with the second set of capabilities; and upon determining that the device supports the received value of the second parameter and the first message comprises a value of the first parameter associated with the second set, setting the maximum transmit power of the device based on the values of the first and second parameters associated with the second set.

Some embodiments comprise, upon determining that the device does not support the received value of the second parameter associated with the second set, receiving a capability enquiry from the wireless network; transmitting capability information comprising an indication that the device does not support the received value of the second parameter; receiving a second message comprising a second value of the first parameter associated with the first set of capabilities; and setting the maximum transmit power of the device based on the second value of the first parameter. Other embodiments include user equipment (e.g. UE or component of a UE) embodying one or more of these methods.

According to a third aspect of the present invention, there is provided apparatus that limits the maximum transmit power of devices operating in a wireless network, each device supporting one of plural sets of transmit power reduction capabilities, the apparatus comprising: a processing system constructed and arranged to cause the apparatus to: transmit a first message comprising a value of a first parameter associated with a first set of capabilities and a value of a second parameter associated with a second set of capabilities, wherein the second set comprises more capabilities than the first set; receive a signal associated with a device's reception of the first message; transmit a capability enquiry to the device; receive capability information comprising an indication of whether the device supports the value of the second parameter; and transmit a second message comprising a value of the first parameter associated with the second set of capabilities upon receiving an indication that the device supports the value of the second parameter.

According to a fourth aspect of the present invention, there is provided apparatus capable of operating in a wireless network subject to maximum transmit power limitations, the apparatus comprising: a processing system constructed and arranged to cause the apparatus, upon receiving a first message comprising a value of a first parameter associated with a first set of capabilities and a value of a second parameter associated with a second set of capabilities, wherein the second set comprises more capabilities than the first set, to: determine whether the apparatus supports the received value of the second parameter; determine whether the first message comprises a value of the first parameter associated with the second set of capabilities; and upon determining that the apparatus supports the received value of the second parameter and the first message comprises a value of the first parameter associated with the second set, set the maximum transmit power of the apparatus based on the values of the first and second parameters associated with the second set.

According to a fifth aspect of the present invention, there is provided a computer program comprising a set of instructions which, when executed on an apparatus capable of limiting the maximum transmit power of devices operating in a wireless network, causes the apparatus to: transmit a first message comprising a value of a first parameter associated with a first set of capabilities and a value of a second parameter associated with a second set of capabilities, wherein the second set comprises more capabilities than the first set; receive a signal associated with a device's reception of the first message; transmit a capability enquiry to the device; receive capability information comprising an indication of whether the device supports the value of the second parameter; and transmit a second message comprising a value of the first parameter associated with the second set of capabilities upon receiving an indication that the device supports the value of the second parameter.

According to a sixth aspect of the present invention, there is provided a computer program comprising a set of instructions which, when executed by an apparatus capable of operating in a wireless network subject to maximum transmit power limitations, causes the apparatus, upon receiving a first message comprising a value of a first parameter associated with a first set of capabilities and a value of a second parameter associated with a second set of capabilities, wherein the second set comprises more capabilities than the first set, to: determine whether the apparatus supports the received value of the second parameter; determine whether the first message comprises a value of the first parameter associated with the second set of capabilities; and upon determining that the apparatus supports the received value of the second parameter and the first message comprises a value of the first parameter associated with the second set, set the maximum transmit power of the apparatus based on the values of the first and second parameters associated with the second set.

There may be provided a non-transitory computer-readable storage medium comprising a set of computer-readable instructions stored thereon, which, when executed by a processing system, cause the processing system to carry out any of the methods as described above.

The processing systems described above may comprise at least one processor and at least one memory including computer program instructions, the at least one memory and the computer program instructions being configured to, with the at least one processor, cause the apparatus at least to perform as described above.

There may also be provided apparatus that limits the maximum transmit power of devices operating in a wireless network, each device supporting one of plural sets of transmit power reduction capabilities, comprising: transmitter means; receiver means; processor means; and at least one memory means including program code that, when executed by the processor means, causes the apparatus to: transmit a first message comprising a value of a first parameter associated with a first set of capabilities and a value of a second parameter associated with a second set of capabilities, wherein the second set comprises more capabilities than the first set; receive a signal associated with a device's reception of the first message; transmit a capability inquiry to the device; receive capability information comprising an indication of whether the device supports the value of the second parameter; and transmit a second message comprising a value of the first parameter associated with the second set of capabilities upon receiving an indication that the device supports the value of the second parameter.

There may also be provided apparatus capable of operating in a wireless network subject to maximum transmit power limitations, comprising: transmitter means; receiver means; processor means; and at least one memory means including program code that, when executed by the processor means, causes the apparatus to: receive a first message comprising a value of a first parameter associated with a first set of capabilities and a value of a second parameter associated with a second set of capabilities, wherein the second set comprises more capabilities than the first set; determine whether the apparatus supports the received value of the second parameter; determine whether the first message comprises a value of the first parameter associated the second set of capabilities; and upon determining that the apparatus supports the received value of the second parameter and the first message comprises a value of the first parameter associated with the second set, set the maximum transmit power of the apparatus based on the values of the first and second parameters associated with the second set.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A shows a high-level block diagram of an exemplary network comprising GERAN, UTRAN, E-UTRAN, and CDMA2000 technologies;

FIG. 1B shows a high-level block diagram of the architecture of the Long Term Evolution (LTE) E-UTRAN and Evolved Packet Core (EPC) network, as standardised by 3GPP;

FIG. 2A shows a high-level block diagram of the E-UTRAN architecture in terms of its constituent components, protocols, and interfaces;

FIG. 2B shows a block diagram of the protocol layers of the control-plane portion of the radio (Uu) interface between a user equipment (UE) and the E-UTRAN;

FIG. 3 shows an exemplary signal flow diagram showing communication between a UE, an evolved Node B (eNB), and a Mobility Management Entity (MME) in an E-UTRAN;

FIG. 4 shows a flowchart of an exemplary method in an apparatus or network equipment, such as an eNB in an E-UTRAN, according to one or more embodiments of the present disclosure;

FIG. 5 shows a flowchart of an exemplary method in an apparatus or device, such as a UE, according to embodiments of the present disclosure;

FIG. 6 shows a flowchart of another exemplary method in an apparatus or device, such as a UE, according to other embodiments of the present disclosure;

FIG. 7 shows a block diagram of an exemplary apparatus or device, such as a UE, according to one or more embodiments of the present disclosure; and

FIG. 8 shows a block diagram an exemplary apparatus or network equipment, such as an eNB in an E-UTRAN, according to one or more embodiments of the present disclosure.

### DETAILED DESCRIPTION

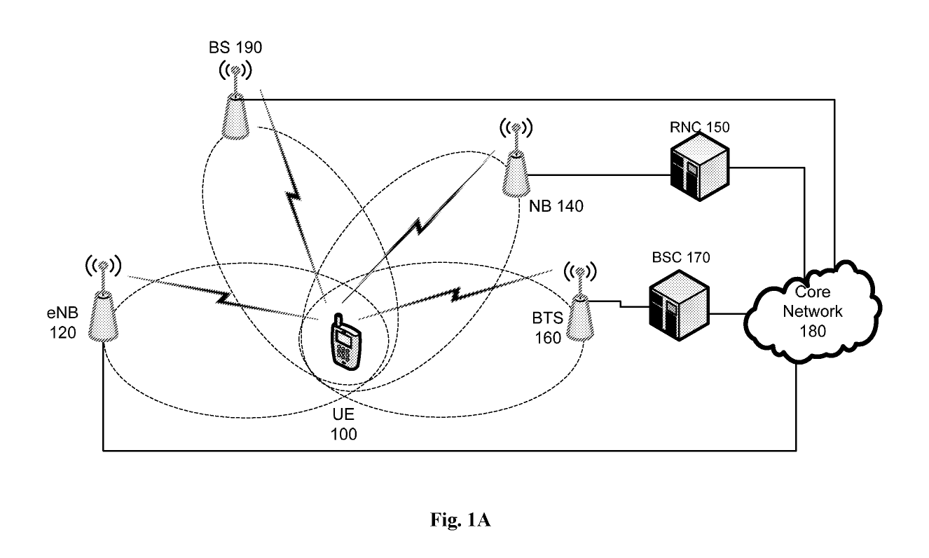

An exemplary network comprising GERAN, UTRAN, E-UTRAN, and CDMA2000 technologies is shown schematically in FIG. 1A. User equipment (UE) 100 is capable of communicating with a plurality of Evolved Node B (eNB) 120, Node B (NB) 140, Base Transceiver Station (BTS) 160, and Base Station (BS) 190. As used within the 3GPP standards, “user equipment” or “UE” means any wireless communication device (e.g. smartphone or computing device) that is capable of communicating with 3GPP-standard-compliant network equipment, such as UTRAN, E-UTRAN, and GERAN (as the second-generation 3GPP radio access network is commonly known). In some implementations, UE may be capable of communicating with a CDMA2000 network according to standards promulgated by the 3GGP2 organisation.

Each of eNB 120, NB 140, BTS 160, and BS 190 serves UEs in a limited geographic area, commonly known as a “cell”, denoted by the respective dashed ovals in FIG. 1A. eNB 120 is responsible for all radio-related functions in the E-UTRAN. The combination of NB 140 and Radio Network Controller (RNC) 150 is responsible for all radio-related functions in the UTRAN, while the combination of BTS 160 and Base Station Controller (BSC) 170 is responsible for all radio-related functions in the GERAN. BS 190 is responsible for radio-related functions in the CDMA2000 network.

Each of eNB 120, NB 140, BTS 160, and BS 190 is connected to a core network 180. In the case of E-UTRAN, eNB 120 connects directly to core network 180, while NB 140 and BTS 160 connect to core network 180 via RNC 150 and BSC 170, respectively. BS 190 may connect to core network 180 directly or via intervening hardware, according to implementation options known to persons of ordinary skill in the art. Although FIG. 1A shows a GERAN, UTRAN, E-UTRAN, and CDMA2000 network each comprising only a single cell, this is merely for purposes of illustration and the person of ordinary skill will understand that any or all of these radio access networks may include multiple cells comprising multiple eNBs, NBs, BTSs, or BSs, as the case may be. Moreover, although FIG. 1A shows four different types of networks, this is merely for purposes of illustration and less than four different types of networks may be present within the scope of the present disclosure. For example, some embodiments of the present disclosure may be used in situations involving only an E-UTRAN and a CDMA2000 network, while other embodiments may be used in situations involving only an E-UTRAN and one or more of a UTRAN and a GERAN. By the same token, exemplary UEs include those configured to operate with E-UTRAN and CDMA2000 technologies, as well those configured to operate with E-UTRAN and one or more of UTRAN and GERAN technologies.

Similarly, although core network 180 is shown as a single entity, persons of ordinary skill will understand that it may comprise different sets of functionality corresponding to different respective radio access networks. For example, core network 180 may include the EPC corresponding to the E-UTRAN. Likewise, core network 180 may include the SGSN/GGSN functionality that enables UEs to transmit data packets via the UTRAN and GERAN. The GGSN is responsible for the interworking between core network 180 and external packet switched networks (e.g. the Internet). The SGSN is responsible for the delivery of IP data packets to and from the UEs within its geographical service area via the UTRAN and GERAN. Core network 180 may include interface functionality known to persons of ordinary skill in the art that enables MMES, SGWs, GGSNs, SGSNs and the like to interoperate and/or be under common control.

The overall architecture of an LTE network is shown schematically in FIG. 1B. E-UTRAN 125 comprises one or more eNBs, such as eNBs 120a, 120b, and 120c, and one or more user equipment (UE), such as UE 100. As briefly mentioned above, E-UTRAN 125 is responsible for all radio-related functions in the network. These functions include radio bearer control, radio admission control, radio mobility control, scheduling, and dynamic allocation of resources to UEs in uplink and downlink, as well as security of the communications with the UE. These functions reside in the eNBs, such as eNBs 120a, 120b, and 120c. The eNBs in the E-UTRAN may communicate with each other via the X2 interface, as shown in FIG. 1B, or via other appropriate interfaces (not shown). The eNBs are also responsible for the E-UTRAN interface to the EPC, specifically the S1 interface to the Mobility Management Entity (MME) and the Serving Gateway (SGW), shown collectively as MME/S-GWs 145a and 145b in FIG. 1B. Generally speaking, MME/S-GW 145a (or 145b, as the case may be) handles both the overall control of UE 100 and data flow between UE 100 and the rest of EPC 135. More specifically, the MME processes the signalling protocols between UE 100 and EPC 135, commonly known as the Non Access Stratum (NAS) protocols. Likewise, the S-GW handles all Internet Protocol (IP) data packets between UE 100 and the EPC 135, and serves as the local mobility anchor for the data bearers when UE 100 moves between eNBs, such as eNBs 120a-c.

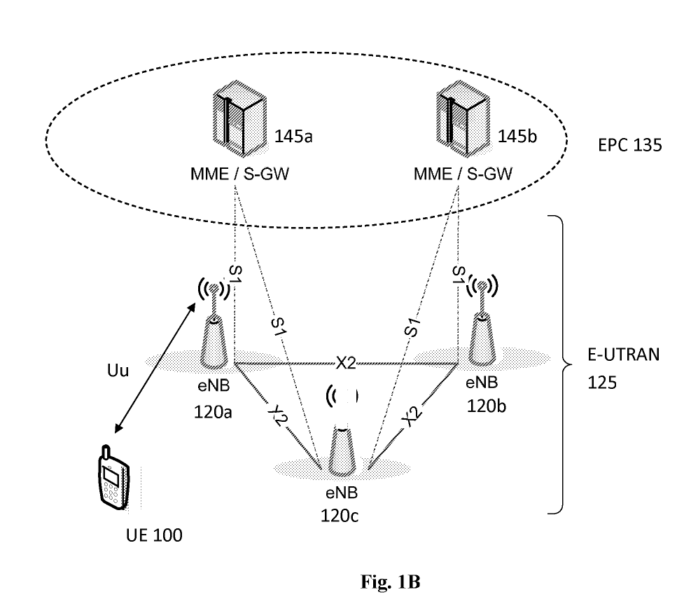

FIG. 2A is a high-level block diagram of LTE architecture in terms of its constituent entities, namely UE, E-UTRAN, and EPC, and high-level functional division into the Access Stratum (AS) and the Non-Access Stratum (NAS). FIG. 2A also further illustrates two particular interface points shown in FIG. 1B, namely the Uu (UE/E-UTRAN Radio Interface) and the S1, each using specific protocols, i.e. Radio Protocols and S1 Protocols, respectively. Each of the two protocols can be further segmented into user plane (or “U-plane”) and control plane (or “C-plane”) protocol functionality. On the Uu interface, the U-plane carries user information (e.g. data packets) while the C-plane is carries control information between UE and E-UTRAN.

FIG. 2B is a block diagram of the C-plane protocol stack on the Uu interface Physical (PHY), Medium Access Control (MAC), Radio Link Control (RLC), Packet Data Convergence Protocol (PDCP), and Radio Resource Control (RRC) layers. Medium Access Control (MAC), Radio Link Control (RLC), Packet Data Convergence Protocol (PDCP), and Radio Resource Control Protocol. The PHY layer is concerned with how and what characteristics are used to transfer data over transport channels on the LTE radio interface. The PHY layer provides several transport channels to higher layers, including the Broadcast Channel (BCH), Downlink Shared Channel (DL-SCH), Uplink Shared Channel (UL-SCH), and Random Access Channel (RACH), among others. The MAC layer provides data transfer services on logical channels, maps logical channels to PHY transport channels, and reallocates PHY resources to support these services. The logical channels provided by the MAC layer include the Broadcast Control Channel (BCCH), Common Control Channel (CCCH), Dedicated Control Channel (DCCH), and Dedicated Traffic Channel (DTCH), among others. The RLC layer provides error detection and/or correction, concatenation, segmentation, and reassembly, reordering of data transferred to or from the upper layers. The PHY, MAC, and RLC layers perform identical functions for both the U-plane and the C-plane. The PDCP layer provides ciphering/deciphering and integrity protection for both U-plane and C-plane, as well as other functions for the U-plane such as header compression.

The RRC layer provides a variety of C-plane services including broadcast of system information (SI); paging; security key management; and establishment, maintenance, and release of connections between a UE and an E-UTRAN. The RRC System Information (SI) messages are transmitted by the eNBs on their respective BCCH logical channels, and comprise a Master Information Block (MIB) and a number of System Information Blocks (SIBs). The MIB includes a limited number of most essential and most frequently transmitted parameters that are needed to acquire other information related to the cell, which is contained in the SIBs. For example, SystemInformationBlockType1 (SIB1) contains information used by a UE to evaluate whether it is allowed to access a cell and defines the scheduling of other system information blocks. The MIB is transmitted by the eNB on the BCH transport channel, while the SIBs are transmitted by the eNB on the DL-SCH transport channel. Both the MIB and SIB1 are transmitted on a fixed, periodic schedule while the other SIBs are scheduled as indicated by SIB1.

Referring again to FIG. 2B, the highest layer of the protocol stack comprises the NAS protocols between the UE and MME. The NAS protocols include EPC mobility management (EMM) procedures, which support user mobility management, and EPC connection management (ECM) procedures, which support user plane bearer activation, modification, and deactivation. For example, the MME creates a UE context when a UE is turned on and attaches to the network. In such case, the MME assigns a unique short temporary identity called the SAE Temporary Mobile Subscriber Identity (S-TMSI) to the UE which identifies the UE context in the MME. This UE context holds user subscription information downloaded from the Home Subscriber Server (HSS) in the user's home network. The HSS subscription information includes the quality-of-service (QoS) profile, any access restrictions for roaming, and information about the packet data networks (PDNs) to which the user may connect. The local storage of subscription data in the MME allows faster execution of procedures such as bearer establishment since it removes the need for the MME to consult the user's HSS every time. In addition to the HSS information, the UE context also contains dynamic information such as the list of bearers that are currently established and the UE's terminal capabilities.

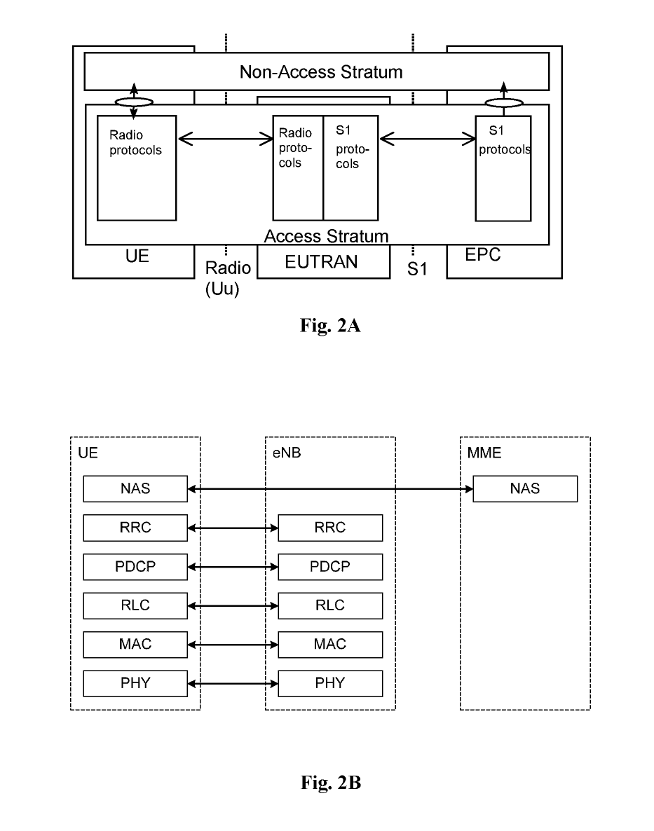

FIG. 3 illustrates exemplary communications between a UE and network equipment, including an eNB and an MME. Initially, a UE may receive various RRC SI messages via the BCCH transmitted by the eNB serving the cell where the UE is located. After the UE receives and processes these SI messages, it may attempt to establish a connection with the E-UTRAN via serving eNB, e.g. for sending data packets. When a UE desires to establish a connection to the E-UTRAN, it sends an RRC RRCConnectionRequest message to its serving eNB. The RRCConnectionRequest message includes the reason why the UE is attempting to establish the connection (i.e. the “establishment cause”) as well as an identifier for the UE, such as the UE's assigned S-TMSI or a random value in case no S-TMSI exists. The UE may send the RRCConnectionRequest message via the CCCH logical channel shared by all UEs in the same cell. As shown in FIG. 3, the eNB responds to the RRCConnectionRequest message with an RRC RRCConnectionSetup message (also sent on CCCH) that includes information about the radio resources assigned by the serving eNB for the requested connection. After configuring its radio resources in accordance with this assignment, and performing various other tasks, the UE responds to the eNB by sending (also on CCCH) an RRC RRCConnectionSetupComplete message that confirms the establishment of the connection.

After establishing the connection, the UE may perform various EMM and/or ECM procedures via communication with the MME using the NAS protocols. One specific EMM procedure is “Attach”, which is used to initiate EPC services and to establish an EMM context and a default bearer. As shown in FIG. 3, the UE initiates the “Attach” procedure by sending an AttachRequest message, to which the MME responds with an AttachAccept message comprising various configuration information related to various EPC features and services. The UE also may indicate in the AttachRequest message that it needs to update its radio capabilities with the network, which will cause MME to trigger the serving eNB to send an RRC UECapabilityInquiry message requesting additional radio access capability information from the UE. The UE responds with an RRC UECapabilityInformation message informing the eNB of the UE's various radio-access-related capabilities. The UE completes the “Attach” procedure by responding to the MME with an AttachComplete message. If the UE wishes to terminate EPC services, it initiates a “detach” procedure (not shown in FIG. 3 or in any subsequent drawings).

Once the UE has established an EMM context (e.g. by the “Attach” procedure), it uses a “Tracking Area Update” (TAU) procedure to update the registration of its tracking area in the network. This may be done when it enters a tracking area in which it has not registered before, or periodically at the request of the network. Another reason for a registered UE to use a TAU procedure is to update certain UE specific parameters stored in the UE context. For example, the UE may initiate a TAU when its network capability information changes, such as when the UE loses or acquires a capability to use a UTRAN. This may happen, for example, when the user or an application on the UE switches off the UE's UMTS radio system. The network capability information relates to how the UE interworks with the EPC via E-UTRAN, including supported algorithms for security, encryption, and integrity; radio access technologies; frequency bands; power levels; etc.

As shown in FIG. 3, the UE initiates the TAU procedure by sending a TrackingAreaUpdateRequest message, to which the MME responds with a TrackingAreaUpdateAccept message comprising EPC mobility management related data, including radio bearer context information for the UE. The UE also may indicate in the TrackingAreaUpdateRequest message that it needs to update its radio capabilities with the network, which will cause MME to trigger the serving eNB to send an RRC UECapabilityInquiry message requesting additional radio access capability information from the UE. The UE responds with an RRC UECapabilityInformation message informing the eNB of the UE's various radio-access-related capabilities. The UE completes the TAU procedure by responding with a TrackingAreaUpdateComplete message.

Although FIG. 3 shows the various communications between the UE, serving eNB, and MME as occurring sequentially in a particular order, persons of ordinary skill will recognise that this is merely exemplary and used for purposes of illustration. The UE, eNB, and MME may exchange the messages in different orders than shown in FIG. 3. Also, these entities also may exchange other messages (not shown) interspersed between the messages shown in FIG. 3. Moreover, the fact that two messages are shown as occurring sequentially is not meant to imply any restrictions on the duration of time between the two messages.

The 3GPP standards provide several ways for controlling the out-of-band spurious emissions of an LTE UE. First, the 3GPP standards specify the maximum output power for a UE transmitting on channels within each of the defined bands. For example, UEs are allowed to transmit at a nominal power level of up to 23 dBm in Band 13 (in Power Class 3). The 3GPP standards also specify the out-of-band emissions allowed when a UE is transmitting at any power level, up to and including the allowed maximum power level. Although these requirements may be adequate for many network deployment scenarios, they are not sufficient for particularly demanding scenarios where for example an LTE band is very close in frequency to a band with stringent out-of-band emission requirements, is not under control of the LTE network operator, or both. One such example is the Band 13 (Block C), which is very close in frequency to the PSNB allocations made by the U.S. and Canadian governments, as discussed above.

The 3PGG standards provide other methods to address these demanding scenarios for LTE networks. For example, eNBs may transmit in SystemInformationBlockType1 (SIB1) a maximum transmit power (pMax) allowed for all UEs operating in idle mode in the cell served by the eNB. The value of pMax may be less than the maximum output power permitted by the 3GPP standards (e.g. 23 dBm in Band 13). Since a UE's out-of-band emissions are proportional to its output power, setting a lower pMax is one way to reduce UE out-of-band emissions to meet a requirement such as −35 dBm/6.25 kHz for Band 13/Block C.

The drawback with this approach, however, is that setting a lower pMax reduces not only the UE's out-of-band emissions but also the UE's transmit power level in the desired band. For example, setting a lower pMax reduces the UE's maximum transmit power across the entire 10-MHz channel of Band 13, not merely the portion nearer to the PSNB. Such an approach negatively affects network coverage and UE data transmission rates. Moreover, while reducing pMax may be sufficient to meet a moderate requirement such as one established by the FCC for PSNB, it is not sufficient to meet a more stringent requirement such as the one established by the operator for Band 13.

For this reason, 3GPP standards specify an enumerated set of Additional Maximum Power Reduction (A-MPR) mechanisms, identified as NS_xx, where “xx”=01 through 32. An eNB may signal a particular NS_xx value to all UEs operating in the cell via the AdditionalSpectrumEmission information element in SystemInformationBlockType2 of the SI message. Each NS_xx value corresponds to one or more particular LTE bands and one or more channel bandwidths within those particular bands. For example, NS_{—}07 is an A-MPR for a 10-MHz LTE channel in Band 13. Each NS_xx specifies a power reduction factor that varies according to the region of the frequency band, such that the power level of transmissions in certain regions of the channel may be reduced more than transmissions in other regions. This approach allows UEs to meet out-of-band emissions requirements without overly impacting network coverage and performance.

For example, NS_{—}07 specifies a power reduction scheme by which transmissions in the lower region of Band 13 (i.e. near PSNB) are reduced by up to 12 dB, transmissions in the upper region of Band 13 are reduced by only 3 dB, and mid-band transmissions are reduced by factors between these two extremes. In comparison, setting pMax=11 dBm would achieve the same desirable 12 dB reduction at the lower region of Band 13 but would also unnecessarily reduce the mid- and upper-band transmissions by the same amount. In this manner, applying NS_{—}07 enables UEs operating in Band 13 to meet the more stringent −57 dBm/6.25 kHz operator PSNB requirement while maintaining acceptable performance with respect to coverage, data rate, etc.

Although the current NS_{—}07 A-MPR mechanism provides these benefits for Band 13 (Block C) in the U.S. market, it is not compatible with the requirements in Canada due to the split Block C configuration and the closer proximity of PSNB to Block C. One approach to address this incompatibility is to add an A-MPR table for a 5-MHz channel in Band 13 to the existing NS_{—}07 specification in Release 11 of the 3GPP standards. Since A-MPR tables are typically programmed and stored into the non-volatile memory of the UE, however, they cannot be reliably updated once the UE is operating in the network. Such an approach will result in at least two different types of UEs operating in an LTE network: Release-11 (and beyond) UEs that are aware of both the current NS_{—}07 for full Band 13 and a prospective A-MPR for one or more 5-MHz sub-bands of Band 13 (hereinafter referred to as “NS_{—}07_{—}5”), and pre-Release-11 (“legacy”) UEs that are only aware of NS_{—}07 for Band 13. Even if they receive a SIB with AdditionalSpectrumEmission indicating NS_{—}07_{—}5, legacy UEs will not apply such an A-MPR value, which may cause them to violate the intended out-of-band spectrum emission limits set by regulatory authority (e.g. Industry Canada) or the network operator.

Accordingly, one problem to be solved is how to enable UE-specific transmit power spectrum modification for UEs operating within a specific frequency band (e.g. Band 13) but supporting different A-MPR values for that band. Another problem to be solved is how to enable the E-UTRAN to distinguish between up-to-date (e.g. Release 11) devices that support the full set of A-MPR values for a particular frequency band and legacy devices that support less than the full set. Being able to make this distinction enables the network to direct a legacy UE not supporting a specific A-MPR value (e.g. NS_{—}07_{—}5) to another band so as to avoid causing the UE to violate emission requirements. It also enables the network to assign an up-to-date UE a different pMax than the value broadcast in SIB1.

Embodiments of the present disclosure solve these and other problems by providing a method for limiting the maximum transmit power of devices operating in a wireless network, each device supporting one of plural sets of transmit power reduction capabilities, comprising transmitting a first message comprising a value of a first parameter associated with a first set of capabilities and a value of a second parameter associated with a second set of capabilities, wherein the second set comprises more capabilities than the first set; receiving a signal associated with a device's reception of the first message; transmitting a capability enquiry to the device; receiving capability information comprising an indication of whether the device supports the value of the second parameter; and transmitting a second message comprising a value of the first parameter associated with the second set of capabilities upon receiving an indication that the device supports the value of the second parameter. Some embodiments further comprise transmitting a second message comprising a value of the first parameter associated with the first set of capabilities upon receiving an indication that the device does not support the value of the second parameter. Some embodiments further comprise determining whether the device supports a value of the second parameter associated with the first set of capabilities, wherein the second message comprises a value of the second parameter associated with the first set of capabilities upon determining the device supports said value.

In some embodiments, the wireless network is a Long-Term Evolution (LTE) Evolved UTRAN (E-UTRAN) and the devices are user equipment (UEs). In some embodiments, the first message comprises a broadcast System Information (SI) message and the second message comprises a dedicated signalling message. In some embodiments, the first parameter comprises maximum transmit power (pMax) for a frequency band and the second parameter comprises Additional Maximum Power Reduction (A-MPR) for the frequency band. Other embodiments include network equipment or apparatus (e.g. eNB or component of an eNB) and computer readable media with program code embodying one or more of these methods.

Embodiments of the present disclosure also include methods for setting the maximum transmit power of a device operating in a wireless network, comprising receiving a first message comprising a value of a first parameter associated with a first set of capabilities and a value of a second parameter associated with a second set of capabilities, wherein the second set comprises more capabilities than the first set; determining whether the device supports the received value of the second parameter; determining whether the first message comprises a value of the first parameter associated the second set of capabilities; and upon determining that the device supports the received value of the second parameter and the first message comprises a value of the first parameter associated with the second set, setting the maximum transmit power of the device based on the values of the first and second parameters associated with the second set.

Some embodiments further comprise, upon determining that the device does not support the received value of the second parameter associated with the second set, receiving a capability enquiry from the wireless network; transmitting capability information comprising an indication that the device does not support the received value of the second parameter; receiving a second message comprising a second value of the first parameter associated with the first set of capabilities; and setting the maximum transmit power of the device based on the second value of the first parameter.

Some embodiments further comprise, upon determining that the device supports the received value of the second parameter and that the first message does not comprise a value of the first parameter associated with the second set, receiving a capability enquiry from the wireless network; transmitting capability information comprising an indication that the device does not support the received value of the second parameter; receiving a second message comprising a value of the first parameter associated with the second set of capabilities; and setting the maximum transmit power of the device based on the second value of the first parameter.

In some embodiments, the wireless network is a Long-Term Evolution (LTE) Evolved UTRAN (E-UTRAN) and the device is a user equipment (UE). In some embodiments, the first message comprises a broadcast System Information (SI) message and the second message comprises a dedicated signalling message. In some embodiments, the first parameter comprises maximum transmit power (pMax) for a frequency band and the second parameter comprises Additional Maximum Power Reduction (A-MPR) for the frequency band. Other embodiments include wireless communication devices or apparatus (e.g. UE or components of a UE) and computer readable media with program code embodying one or more of these methods.

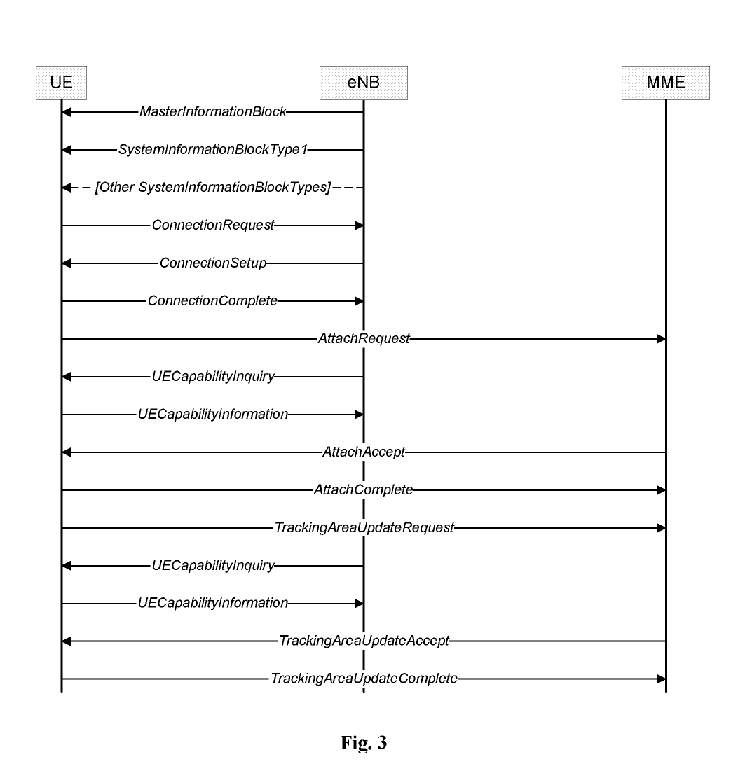

FIG. 4 is a flowchart of an exemplary method for network equipment or apparatus, according to one or more embodiments of the present disclosure. In some embodiments, the network equipment or apparatus may be a wireless base station such as, for example, an eNB or component of an eNB. The network equipment is capable of transmitting System Information (SI) messages on a broadcast control channel (BCCH) and of establishing, updating, and terminating connections with compatible wireless communication devices (e.g. UEs) by exchanging RRC messages including those shown in FIG. 3 according to established protocols. The network equipment also is capable of communicating with other compatible network equipment such as, for example, an MME. Although the method is illustrated by blocks in the particular order of FIG. 4, this order is merely exemplary and the steps of the method may be performed in a different order and may be combined and/or divided into blocks having different functionality than shown in FIG. 4.

In block 400, the network equipment transmits a BCCH with SI messages including SIBs comprising various parameter values related to configuration of transmit power spectrum for UEs receiving the message. As understood by persons of ordinary skill in the art, the operation of block 400 may comprise repetitive and/or periodic BCCH transmissions of the SI messages with relevant SIBs. In some embodiments, the SIBs include A-MPR value NS_xx_{new}, the A-MPR value to be used by devices that communicate with the network equipment in the uplink band. As used herein, the subscript “new” indicates that the value of a parameter (e.g. maximum transmit power or A-MPR) may be understood by certain later-release devices (such as UEs) but not by certain older devices (so-called “legacy” devices). The subscript “leg” indicates that the value of a parameter is also understood by legacy devices. One example of NS_xx_{new} is NS_{—}07_{—}5, an A-MPR for a 5-MHz subband of Band 13 (e.g. block C1 or block C2). However, persons of ordinary skill will understand that an NS_xx_{new} may be defined for any frequency band, or subset or superset thereof, currently specified in the 3GPP standards. In some embodiments, the frequency band associated with NS_xx_{new} may correspond to an integral number of allowed channel bandwidths (e.g. 1.4, 3, 5, 10, and 20 MHz bandwidths for LTE channels).

In these embodiments, the SIBs also include pMax_{leg}, which is the value of the maximum transmit power in the present uplink band to be used by legacy devices. In some embodiments, the SIBs also may include a value, pMax_{new}, of the maximum transmit power in the present uplink band to be used in combination with A-MPR value NS_xx_{new}. When both NS_xx_{new} and pMax_{new} are included, the two may be transmitted together as an information element in a single SIB (e.g. SIB2) or separately in different SIBs.

In block 410, the network equipment receives an enquiry trigger signal. In some embodiments, the enquiry trigger signal is related to a non-access-related procedure initiated by a device that has received the BCCH signal transmitted in block 400. In some embodiments, the trigger signal received in block 410 may be the result of a mobility management procedure initiated by the device, such as an “attach” or TAU procedure. In some embodiments, the enquiry trigger signal may be received from an MME. In response to the trigger, the network equipment transmits a capability enquiry to the device in block 415. In some embodiments, the capability enquiry may be an RRC UECapabilityInquiry message, as described above with reference to FIG. 3. In block 420, the network equipment receives capability information from the device. In some embodiments, the capability information may be an RRC UECapabilityInformation message, as described above with reference to FIG. 3.

The capability information received in block 420 comprises an indication of whether or not the device supports A-MPR value NS_xx_{new} that was transmitted in block 400. In block 425, the network equipment reads and interprets this indicator. If the indicator is positive (i.e. the device supports NS_xx_{new}), the network equipment proceeds to block 430 where it determines whether the capability information also indicates that the device can support a different A-MPR (i.e. less power reduction in one or more frequencies of the band) than NS_xx_{new}, or a modified version of NS_xx_{new}. If so, then the network equipment proceeds to block 435a where it determines that the device should utilise the combination of A-MPR value NS_xx_{new2} (≠TS_xx_{new}) and maximum transmit power value pMax_{new}. If no different A-MPR is indicated, then the network equipment proceeds to block 435b where it determines that the device should utilise maximum transmit power value pMax_{new} in combination with A-MPR value NS_xx_{new} as received in the SI message transmitted in block 400. The network equipment then proceeds to block 450.

On the other hand, if the network equipment determines in block 425 that the NS_xx_{new} support indicator received in block 420 is negative (i.e. the device does not support NS_xx_{new}), the network equipment proceeds to block 440 where it determines whether another A-MPR value is available for the present uplink band and supported by legacy devices. For example, a legacy A-MPR value for Band 13 is NS_{—}07. If the network equipment determines in block 440 that such a legacy A-MPR value (denoted NS_xx_{leg}) is available and supported, it proceeds to block 445a where it determines that the device should utilise maximum transmit power value pMax_{leg2} (which may be the same as or different from pMax_{leg} provided in the SI message transmitted in block 400) in combination with A-MPR value NS_xx_{leg}. If no such legacy A-MPR is available and supported, the network equipment proceeds to block 445b where it determines that the device should utilise maximum transmit power value pMax_{leg2} without A-MPR.

The network equipment then proceeds to block 450, where it transmits a message to the device via dedicated signalling (e.g. RRC message), indicating the pMax value and, in some embodiments, the A-MPR value to be used by the device. For example, the network equipment may not include an A-MPR parameter in the message where no A-MPR value was determined (e.g. block 445b). In some embodiments, the network equipment may not include an A-MPR parameter in the message if the determined A-MPR value is the same NS_xx_{new} value provided in the BCCH SI message (e.g. block 435b). In such embodiments, the network equipment may optionally include in the message an indicator for the receiving device to utilise the A-MPR value provided via BCCH in combination with the pMax value included in the message.

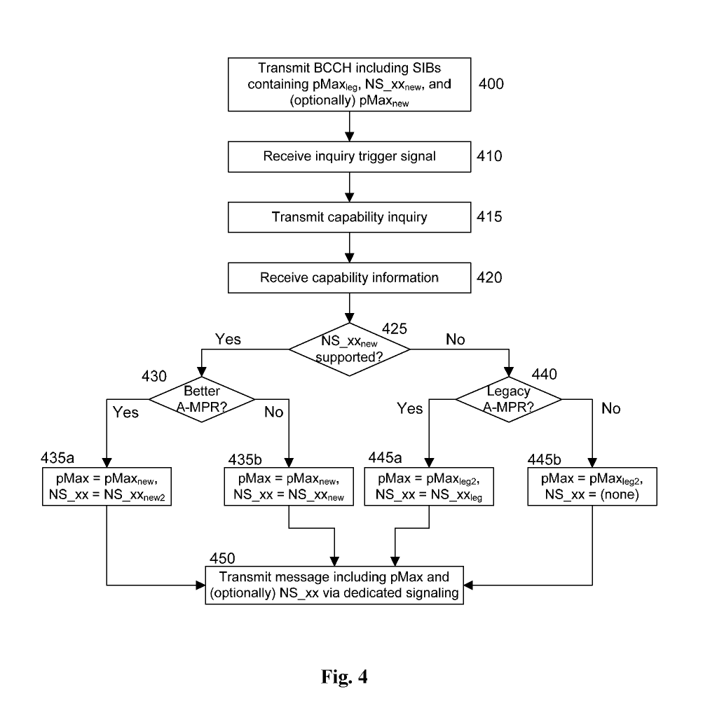

FIG. 5 is a flowchart of an exemplary method for a device or apparatus according to one or more embodiments of the present disclosure. In some embodiments, the device or apparatus may be a wireless communication device such as, for example, a UE or component of a UE (e.g. a modem). The device is capable of receiving SI messages on a BCCH and of establishing, updating, and terminating connections with various network equipment by exchanging access-related messages (e.g. RRC messages with an eNB) and non-access-related messages (e.g. mobility management messages with an MME) according to established protocols. In particular, the device is capable of exchanging dedicated signalling messages related to modification of the device's transmit power spectrum with a network equipment (e.g. an eNB). Although the method is illustrated by blocks in the particular order of FIG. 5, this order is merely exemplary and the steps of the method may be performed in a different order and may be combined and/or divided into blocks having different functionality than shown in FIG. 5.

In block 500, the device receives an SI message via the BCCH transmitted by a network equipment (e.g. the device's serving eNB) that includes SIBs comprising various parameters related to configuration of transmit power spectrum for devices receiving the message. In some embodiments, the SIBs include A-MPR value NS_xx_{new}, which indicates the A-MPR value to be used by devices that communicate with the network equipment in the uplink band. One example of NS_xx_{new} is NS_{—}07_{—}5, an A-MPR for a 5-MHz subband of Band 13 which was discussed previously. In these embodiments, the SIBs also include pMax_{leg}, which is the maximum transmit power in the present uplink band to be used by legacy devices. In some embodiments, the SIBs also may include the value pMax_{new}, which is the maximum transmit power in the present uplink band to be used in conjunction with A-MPR mechanism NS_xx_{new}. When both NS_xx_{new} and pMax_{new} are included, the two values may be received together as an information element in a single SIB (e.g. SIB2) or separately in different SIBs. In block 505, the device reads these various values from the SIBs in which they are included.

In block 510, the device determines whether it supports the A-MPR value NS_xx_{new}. If so, the device proceeds to block 515 where it determines whether a value of parameter pMax (e.g. pMax_{new}) associated with NS_xx_{new} is included in the SIBs of the received BCCH message. If it determines that such a value is included, the device proceeds to block 580a where it reads the pMax_{new} value from the SIB and sets its A-MPR and maximum transmit power to NS_xx_{new} and pMax_{new}, respectively. The device then proceeds to block 590. On the other hand, if it determines in block 515 that pMax_{new} is not included, then the device proceeds to block 520 where it initiates a non-access-related procedure with the network. In some embodiments, the procedure is a mobility management procedure such as an “attach” or a “tracking area update” (TAU) procedure. In some embodiments, the device initiates the procedure with an MME.

In block 525, the device receives a capability enquiry from the network equipment. In some embodiments, the capability enquiry may be an RRC UECapabilityInquiry message sent by the serving eNB, as described above with reference to FIG. 3. In block 530, the device transmits capability information to the network equipment. In some embodiments, the capability information may comprise an RRC UECapabilityInformation message sent to the serving eNB, as described above with reference to FIG. 3. The capability information sent by the device in block 530 comprises an indication that the device supports A-MPR value NS_xx_{new}. In addition, the device may also indicate in the capability information whether it can support a different A-MPR value (i.e. less power reduction in one or more frequencies within the band) than NS_xx_{new}, or a modified version of NS_xx_{new}.

In block 535, the device receives a message from the network equipment via dedicated signalling (e.g. RRC message from the serving eNB) comprising maximum transmit power value pMax_{new}. In some embodiments, the dedicated signalling message also may comprise a value of the A-MPR parameter, NS_xx_{new2} (≠TS_xx_{new}), to be used in combination with maximum transmit power value pMax_{new}. The A-MPR value may be included in the message, for example, if the device indicated in the message sent in block 530 that it could support a different A-MPR value than NS_xx_{new} received in the broadcast message. In block 540, the device sets its maximum transmit power to pMax_{new} and proceeds to block 545 where it determines whether the A-MPR parameter was included in the message received in block 535. If it determines that the parameter was included, the device proceeds to block 580b where it sets its A-MPR value to NS_xx_{new2}; otherwise, it proceeds to block 580c where it sets its A-MPR value to NS_xx_{new}. In some embodiments, the operation of block 545 may comprise determining whether the message received in block 535 included an indicator to use the A-MPR value to NS_xx_{new} received in the broadcast message in block 500. In such embodiments, if the device determines that such an indicator is present, it proceeds to block 580c. In either case, after block 580c or 580d, the device proceeds to block 590.

Returning to block 510, if the device determines that it does not support the A-MPR value NS_xx_{new}, it proceeds to block 550 where it initiates a non-access-related procedure with the network. In block 555, the device receives a capability enquiry from the network equipment. The operations of blocks 550 and 555 are substantially the same as the operations in blocks 520 and 525, respectively, which were described in detail above. In block 560, the device transmits capability information to the network equipment. In some embodiments, the capability information may comprise an RRC UECapabilityInformation message sent to the serving eNB, as described above with reference to FIG. 3. The capability information sent by the device in block 560 comprises an indication that the device does not support A-MPR value NS_xx_{new}.

In block 565, the device receives a message from the network equipment via dedicated signalling (e.g. RRC message from the serving eNB) comprising maximum transmit power value pMax_{leg2} to be used by the device. The value of pMax_{leg2} may be the same as or different from the value pMax_{leg} provided in the SI message received in block 500. In some embodiments, the dedicated signalling message also may comprise a value of the A-MPR parameter, NS_xx_{leg}, to be used in combination with pMax_{leg2}. This parameter may be received, for example, if the network equipment determines that an A-MPR mechanism is available for the present uplink band and supported by legacy devices, such as the device. For example, a legacy A-MPR mechanism for Band 13 is NS_{—}07. In block 570, the device sets its maximum transmit power to pMax_{leg2} and proceeds to block 575 where it determines whether parameter NS_xx_{leg} was included in the message received in block 565. If it determines that the parameter was included, the device proceeds to block 580d where it sets its A-MPR mechanism to NS_xx_{leg}; otherwise, it proceeds to block 580e where it determines that it should utilise maximum transmit power value pMax_{leg2} without any A-MPR. In either case, the device proceeds to block 590, where it applies the determined maximum transmit power and, where available, an associated A-MPR to subsequent transmissions in the uplink band.

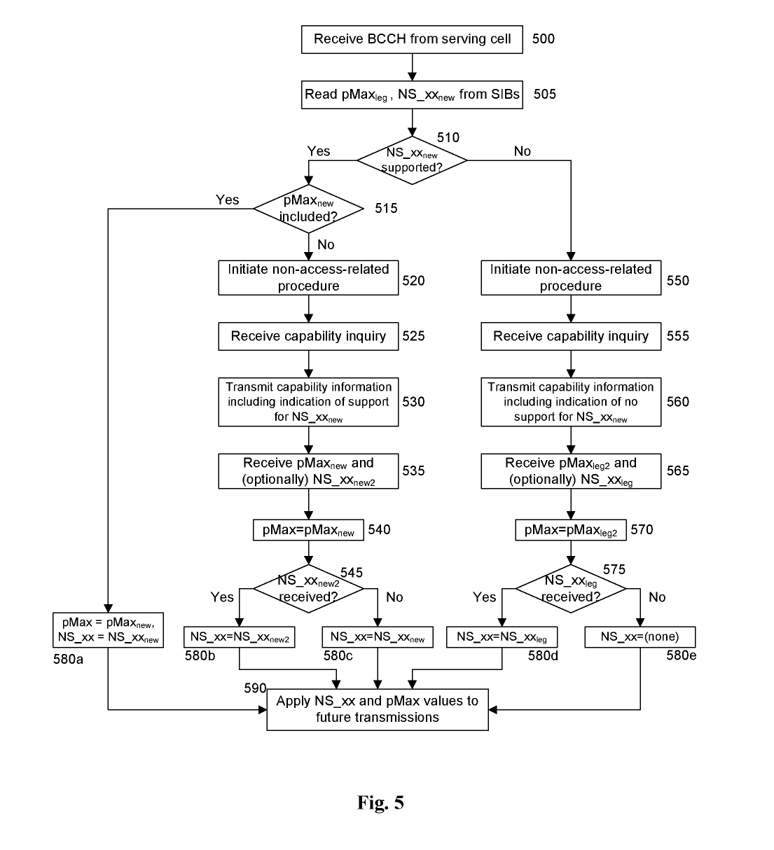

FIG. 6 is a flowchart of another exemplary method for a device or apparatus according to one or more other embodiments of the present disclosure. In some embodiments, the device or apparatus may be a wireless communication device such as, for example, a UE or component of a UE (e.g. a modem). The device is capable of receiving SI messages on a BCCH and of establishing, updating, and terminating connections with various network equipment by exchanging access-related messages (e.g. RRC messages with an eNB) and non-access-related messages (e.g. mobility management messages with an MME) according to established protocols. In contrast to the method illustrated by and described above with reference to FIG. 5, the method shown in FIG. 6 may be used in a device that is not capable of exchanging dedicated signalling messages related to modification of the device's transmit power spectrum. Although the method is illustrated by blocks in the particular order of FIG. 6, this order is merely exemplary and the steps of the method may be performed in a different order and may be combined and/or divided into blocks having different functionality than shown in FIG. 6.

In block 600, the device receives an SI message via the BCCH transmitted by a network equipment (e.g. the device's serving eNB) that includes SIBs comprising various parameters related to configuration of transmit power spectrum for devices receiving the message. In some embodiments, the SIBs include A-MPR value NS_xx_{new}, which indicates the A-MPR to be used by devices when transmitting in the uplink band. One example of NS_xx_{new} is NS_{—}07_{—}5, an A-MPR for a 5-MHz subband of Band 13 which was discussed previously. In these embodiments, the SIBs also include pMax_{leg}, which is the maximum transmit power in the present uplink band to be used by legacy devices. In some embodiments, the SIBs may also include pMax_{new}, a value of the maximum transmit power in the present uplink band to be used in conjunction with A-MPR value NS_xx_{new}. When both NS_xx_{new} and pMax_{new} are included, the two values may be received together as an information element in a single SIB (e.g. SIB2) or separately in different SIBs. In block 605, the device reads these various parameter values from the SIBs in which they are included.

In block 610, the device determines whether it supports the A-MPR value NS_xx_{new}. If so, the device proceeds to block 615 where it determines whether a value of the maximum transmit power parameter (e.g. pMax_{new}) associated with NS_xx_{new} is included in the SIBs of the received BCCH message. If it determines that such a value is included, the device proceeds to block 620a where it reads the pMax_{new} value from the SIB and sets its A-MPR mechanism and maximum transmit power to NS_xx_{new} and pMax_{new}, respectively. On the other hand, if it determines in block 615 that pMax_{new} is not included, then the device proceeds to block 620b where it sets its A-MPR to NS_xx_{new} and maximum transmit power to pMax_{leg}, the value received in the SI message via the BCCH. In either case, the device then proceeds to block 630.

Returning to block 610, if the device determines that it does not support the A-MPR value NS_xx_{new}, it proceeds to block 620c where it determines that it should utilise maximum transmit power value pMax_{leg2} without any A-MPR. The device then proceeds to block 630, where it applies the determined maximum transmit power and, if available, an associated A-MPR to subsequent transmissions in the uplink band.

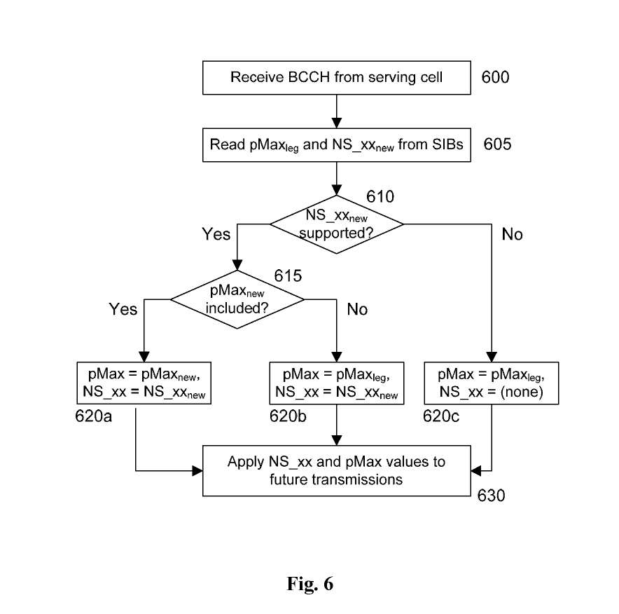

FIG. 7 is a block diagram of exemplary apparatus 700 utilising certain embodiments of the present disclosure, including one or more of the methods described above with reference to FIGS. 4 through 6. In some embodiments, apparatus 700 comprises a wireless communication device, such as a UE or component of a UE (e.g. a modem). Apparatus 700 comprises processor 710 which is operably connected to program memory 720 and data memory 730 via bus 770, which may comprise parallel address and data buses, serial ports, or other methods and/or structures known to those of ordinary skill in the art. Program memory 720 comprises software code executed by processor 710 that enables apparatus 700 to communicate with one or more other devices using protocols according to various embodiments of the present disclosure, including the LTE PHY protocol layer and improvements thereto, including those described above with reference to FIGS. 2 through 6.

Program memory 720 also comprises software code executed by processor 710 that enables apparatus 700 to communicate with one or more other devices using other protocols or protocol layers, such as LTE MAC, RLC, PDCP, and RRC layer protocols standardised by 3GPP, or any improvements thereto; GSM, UMTS, High Speed Packet Access (HSPA), General Packet Radio Service (GPRS), Enhanced Data rate for GSM Evolution (EDGE), and/or CDMA2000 protocols; Internet protocols such as Internet Protocol (IP), Transmission Control Protocol (TCP), and User Datagram Protocol (UDP); or any other protocols utilised in conjunction with radio transceiver 740, user interface 750, and/or host interface 760. Program memory 720 further comprises software code executed by processor 710 to control the functions of apparatus 700, including configuring and controlling various components such as radio transceiver 740, user interface 750, and/or host interface 760. Such software code may be specified or written using any known or future developed programming language, such as e.g. Java, C++, C, and Assembler, as long as the desired functionality, e.g. as defined by the implemented method steps, is preserved. Program memory 720 may comprise non-volatile memory (e.g. flash memory), volatile memory (e.g. static or dynamic RAM), or a combination thereof.

Data memory 730 may comprise memory area for processor 710 to store variables used in protocols, configuration, control, and other functions of apparatus 700. For example, information associated with one or more of the tables shown in FIGS. 7A, 7B, and 7C may be stored in data memory 730. Data memory 730 may comprise non-volatile memory, volatile memory, or a combination thereof.

Persons of ordinary skill in the art will recognise that processor 710 may comprise multiple individual processors (not shown), each of which implements a portion of the functionality described above. In such case, multiple individual processors may be commonly connected to program memory 720 and data memory 730 or individually connected to multiple individual program memories and or data memories. More generally, persons of ordinary skill in the art will recognise that various protocols and other functions of apparatus 700 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio transceiver 740 may comprise radio-frequency transmitter and/or receiver functionality that enables apparatus 700 to communicate with other equipment supporting like wireless communication standards. In an exemplary embodiment, radio transceiver 740 includes an LTE transmitter and receiver that enable apparatus 700 to communicate with various E-UTRANs according to standards promulgated by 3GPP. In some embodiments, radio transceiver 740 includes circuitry, firmware, etc. necessary for apparatus 700 to communicate with network equipment using the LTE PHY protocol layer structures, methods, and improvements thereto such as those described herein. In some embodiments, radio transceiver 740 includes circuitry, firmware, etc. necessary for apparatus 700 to communicate with various UTRANs and GERANs according to 3GPP standards known to persons of ordinary skill in the art. In some embodiments, radio transceiver 740 includes circuitry, firmware, etc. necessary for apparatus 700 to communicate with various CDMA2000 networks according to 3GPP2 and/or 3GPP standards known to persons of ordinary skill in the art.

In some embodiments, radio transceiver 740 is capable of communicating on a plurality of LTE frequency-division-duplex (FDD) frequency bands 1 through 25, as specified in 3GPP standards. In some embodiments, radio transceiver 740 is capable of communicating on a plurality of LTE time-division-duplex (TDD) frequency bands 33 through 43, as specified in 3GPP standards. In some embodiments, radio transceiver 740 is capable of communicating on a combination of these LTE FDD and TDD bands, as well as other bands specified in the 3GPP standards. In some embodiments, radio transceiver 740 is capable of communicating on one or more unlicensed frequency bands, such as the ISM band in the region of 2.4 GHz. The radio functionality particular to each of these embodiments may be coupled with or controlled by other circuitry in apparatus 700, such as processor 710 executing protocol program code stored in program memory 720.

User interface 750 may take various forms depending on the particular embodiment of apparatus 700. In some embodiments, apparatus 700 is a mobile phone, in which case user interface 750 may comprise one or more of a microphone, a loudspeaker, slidable buttons, depressable buttons, a keypad, a keyboard, a display, a touchscreen display, and/or any other user-interface features commonly found on mobile phones. In some embodiments, apparatus 700 may comprise a tablet device, in which case user interface 750 may be primarily, but not strictly limited to, a touchscreen display. In other embodiments, apparatus 700 may be a data modem capable of being utilised with a host device, e.g. a tablet, laptop computer, etc. In such case, apparatus 700 may be fixedly integrated with or may be removably connectable to the host device, such as via a USB port. In these embodiments, user interface 750 may be very simple or may utilise features of the host computing device, such as the host device's display and/or keyboard.

Host interface 760 of apparatus 700 also may take various forms depending on the particular embodiment of apparatus 700. In embodiments where apparatus 700 is a mobile phone or tablet, host interface 760 may comprise for example a USB interface, an HDMI interface, or the like. In the embodiments where apparatus 700 is a data modem capable of being utilised with a host device, host interface may be for example a USB or PCMCIA interface.

In some embodiments, apparatus 700 may comprise more functionality than is shown in FIG. 7. In some embodiments, apparatus 700 may also comprise functionality such as a video and/or still-image camera, media player, etc., and radio transceiver 740 may include circuitry necessary to communicate using additional radio-frequency communication standards including GSM, UMTS, High Speed Packet Access (HSPA), General Packet Radio Service (GPRS), Enhanced Data rate for GSM Evolution (EDGE), Long Term Evolution (LTE), CDMA2000, WiFi, Bluetooth, GPS, and/or others. Persons of ordinary skill in the art will recognise the above list of features and radio-frequency communication standards is merely exemplary and not intended to limit the scope of the present disclosure. Accordingly, processor 710 may execute software code stored in program memory 720 to control such additional functionality.

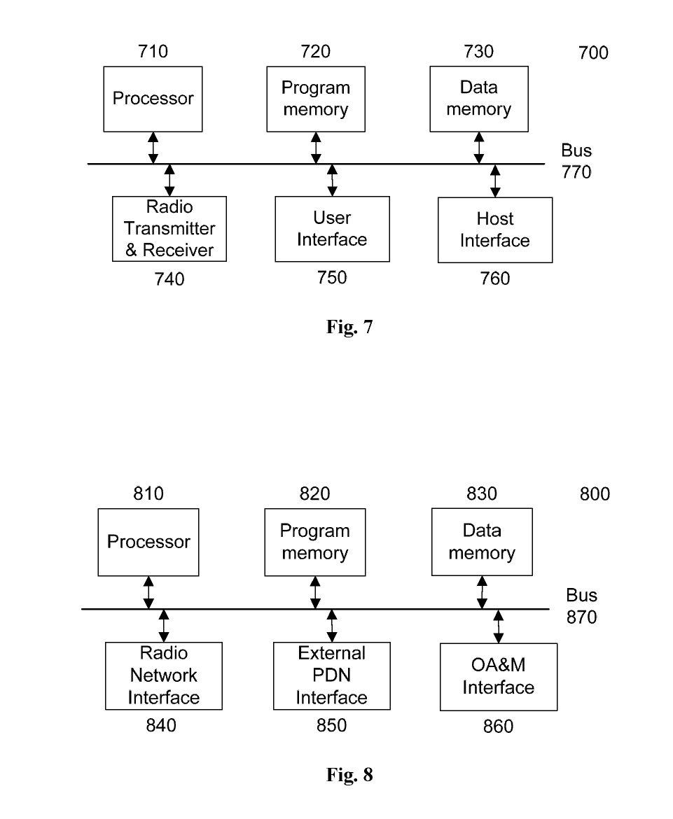

FIG. 8 is a block diagram of an exemplary apparatus 800 utilising certain embodiments of the present disclosure, including those described herein with reference to FIGS. 2 to 6. In some embodiments, apparatus 800 comprises a network equipment such as an evolved Node B (eNB) or component of an eNB. Apparatus 800 includes processor 810 which is operably connected to program memory 820 and data memory 830 via bus 870, which may comprise parallel address and data buses, serial ports, or other methods and/or structures known to persons of ordinary skill in the art. Program memory 820 comprises software code executed by processor 810 that enables apparatus 800 to communicate with one or more other devices or apparatus using protocols according to various embodiments of the present disclosure, including the Radio Resource Control (RRC) protocol, EPS Mobility Management (EMM) protocol, and improvements thereto. Program memory 820 also comprises software code executed by processor 810 that enables apparatus 800 to communicate with one or more other devices using other protocols or protocol layers, such as one or more of the PHY, MAC, RLC, PDCP, and RRC layer protocols standardised by 3GPP, or any other higher-layer protocols (e.g. NAS protocols such as EMM and ECM) utilised in conjunction with radio network interface 840 and core network interface 850. By way of example and without limitation, core network interface 850 may comprise the Si interface and radio network interface 850 may comprise the Uu interface, as standardised by 3GPP. Program memory 820 further comprises software code executed by processor 810 to control the functions of apparatus 800, including configuring and controlling various components such as radio network interface 840 and core network interface 850.

Data memory 830 may comprise memory area for processor 810 to store variables used in protocols, configuration, control, and other functions of apparatus 800. As such, program memory 820 and data memory 830 may comprise non-volatile memory (e.g. flash memory, hard disk, etc.), volatile memory (e.g. static or dynamic RAM), network-based (e.g. “cloud”) storage, or a combination thereof. Persons of ordinary skill in the art will recognise that processor 810 may comprise multiple individual processors (not shown), each of which implements a portion of the functionality described above. In such case, multiple individual processors may be commonly connected to program memory 820 and data memory 830 or individually connected to multiple individual program memories and/or data memories. More generally, persons of ordinary skill in the art will recognise that various protocols and other functions of apparatus 800 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 840 may comprise transmitters, receivers, signal processors, ASICs, antennas, beamforming units, and other circuitry that enables apparatus 800 to communicate with other equipment such as, in some embodiments, a plurality of compatible user equipment (UEs). In some embodiments, radio network interface may comprise various protocols or protocol layers, such as the LTE PHY, MAC, RLC, PDCP, and RRC layer protocols standardised by 3GPP, improvements thereto such as described herein with reference to one of more FIGS. 2 through 6. Likewise, radio interface 840 may facilitate communication via other higher-layer protocols between other devices or apparatus (e.g. NAS protocols between UEs and MMEs). In some embodiments, the radio network interface 840 may comprise a PHY layer based on orthogonal frequency division multiplexing (OFDM) or orthogonal frequency division multiple access (OFDMA) technologies, which are known to persons of ordinary skill in the art.

Core network interface 850 may comprise transmitters, receivers, and other circuitry that enables apparatus 800 to communicate with other equipment in a core network such as, in some embodiments, circuit-switched (CS) and/or packet-switched Core (PS) networks. In some embodiments, core network interface 850 may comprise the 51 interface standardised by 3GPP. In some embodiments, core network interface 850 may comprise one or more interfaces to one or more SGWs, MMEs, SGSNs, GGSNs, and other physical devices that comprise functionality found in GERAN, UTRAN, E-UTRAN, and CDMA2000 core networks that are known to persons of ordinary skill in the art. In some embodiments, these one or more interfaces may be multiplexed together on a single physical interface. In some embodiments, lower layers of core network interface 850 may comprise one or more of asynchronous transfer mode (ATM), Internet Protocol (IP)-over-Ethernet, SDH over optical fibre, T1/E1/PDH over a copper wire, microwave radio, or other wired or wireless transmission technologies known to those of ordinary skill in the art.

OA&M interface 860 may comprise transmitters, receivers, and other circuitry that enables apparatus 800 to communicate with external networks, computers, databases, and the like for purposes of operations, administration, and maintenance of apparatus 800 or other network equipment operably connected thereto. Lower layers of OA&M interface 860 may comprise one or more of asynchronous transfer mode (ATM), Internet Protocol (IP)-over-Ethernet, SDH over optical fibre, T1/E1/PDH over a copper wire, microwave radio, or other wired or wireless transmission technologies known to those of ordinary skill in the art. Moreover, in some embodiments, one or more of radio network interface 840, core network interface 850, and OA&M interface 860 may be multiplexed together on a single physical interface, such as the examples listed above.

As described herein, a device or apparatus may be represented by a semiconductor chip, a chipset, or a (hardware) module comprising such chip or chipset; this, however, does not exclude the possibility that a functionality of a device or apparatus, instead of being hardware implemented, may be implemented as a software module such as a computer program or a computer program product comprising executable software code portions for execution or being run on a processor. A device or apparatus may be regarded as a device or apparatus, or as an assembly of multiple devices and/or apparatuses, whether functionally in cooperation with or independently of each other. Moreover, devices and apparatus may be implemented in a distributed fashion throughout a system, so long as the functionality of the device or apparatus is preserved. Such and similar principles are considered as known to a skilled person.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for limiting the maximum transmit power of devices operating in a wireless network, each device supporting one of plural sets of transmit power reduction capabilities, the method comprising:
transmitting a first message comprising a value of a first parameter associated with a first set of capabilities and a value of a second parameter associated with a second set of capabilities, wherein the second set comprises more capabilities than the first set;
receiving a signal associated with a device's reception of the first message;
transmitting a capability enquiry to the device;
receiving capability information comprising an indication of whether the device supports the value of the second parameter; and
transmitting a second message comprising a value of the first parameter associated with the second set of capabilities upon receiving an indication that the device supports the value of the second parameter.

2. A method according to claim 1, wherein, in the case that the capability information comprises an indication that the device is capable of supporting at least one additional value of the second parameter than the value included in the first message, the second message comprises a value of the second parameter different from the value included in the first message.

3. A method according to claim 1, comprising transmitting a second message comprising a value of the first parameter associated with the first set of capabilities upon receiving an indication that the device does not support the value of the second parameter.

4. A method according to claim 3, further comprising determining whether the device supports a value of the second parameter associated with the first set of capabilities, wherein said second message, which comprises a value of the first parameter associated with the first set of capabilities, comprises a value of the second parameter associated with the first set of capabilities upon determining the device supports said value.

5. A method according to claim 1, wherein the second message comprises one of the value of the second parameter included in the first message and an indication to use the value of the second parameter included in the first message.

6. A method according to claim 1, wherein:
the wireless network is a Long-Term Evolution (LTE) Evolved UTRAN (E-UTRAN);
the device is a user equipment (UE);
the first message comprises a broadcast System Information (SI) message;
the second message comprises a dedicated signalling message;
the first parameter comprises maximum transmit power (pMax) for a frequency band; and
the second parameter comprises Additional Maximum Power Reduction (A-MPR) for the frequency band.

7-8. (canceled)

9. A method for setting the maximum transmit power of a device operating in a wireless network, the method comprising:
receiving a first message comprising a value of a first parameter associated with a first set of capabilities and a value of a second parameter associated with a second set of capabilities, wherein the second set comprises more capabilities than the first set;
determining whether the device supports the received value of the second parameter;
determining whether the first message comprises a value of the first parameter associated with the second set of capabilities; and
upon determining that the device supports the received value of the second parameter and the first message comprises a value of the first parameter associated with the second set, setting the maximum transmit power of the device based on the values of the first and second parameters associated with the second set.

10. A method according to claim 9, comprising, upon determining that the device does not support the received value of the second parameter associated with the second set:
receiving a capability enquiry from the wireless network;
transmitting capability information comprising an indication that the device does not support the received value of the second parameter;
receiving a second message comprising a second value of the first parameter associated with the first set of capabilities; and
setting the maximum transmit power of the device based on the second value of the first parameter.

11. A method according to claim 10, comprising, upon determining that the second message comprises a value of the second parameter associated with the first set of capabilities, adjusting the maximum transmit power setting of the device based upon said value.

12. A method according to claim 9, comprising, upon determining that the device supports the received value of the second parameter and that the first message does not comprise a value of the first parameter associated with the second set:
receiving a capability enquiry from the wireless network;
transmitting capability information comprising an indication that the device does not support the received value of the second parameter;
receiving a second message comprising a value of the first parameter associated with the second set of capabilities; and
setting the maximum transmit power of the device based on the second value of the first parameter.

13. A method according to claim 12, comprising:
determining whether the second message comprises a second value of the second parameter associated with the second set of capabilities; and
adjusting the maximum transmit power setting of the device based upon the second value if the second message comprises said second value.

14. A method according to claim 13, comprising adjusting the maximum transmit power setting of the device based upon the value of the second parameter received in the first message if the second message does not comprise said second value.

15. A method according to claim 13, comprising:
determining whether the second message comprises an indication to use the value of the second parameter received in the first message; and
adjusting the maximum transmit power setting of the device based upon the value of the second parameter received in the first message if the second message comprises said indication.

16-21. (canceled)

22. Apparatus that limits the maximum transmit power of devices operating in a wireless network, each device supporting one of plural sets of transmit power reduction capabilities, the apparatus comprising:
a processing system constructed and arranged to cause the apparatus to:
transmit a first message comprising a value of a first parameter associated with a first set of capabilities and a value of a second parameter associated with a second set of capabilities, wherein the second set comprises more capabilities than the first set;
receive a signal associated with a device's reception of the first message;
transmit a capability enquiry to the device;
receive capability information comprising an indication of whether the device supports the value of the second parameter; and
transmit a second message comprising a value of the first parameter associated with the second set of capabilities upon receiving an indication that the device supports the value of the second parameter.

23. Apparatus according to claim 22, wherein in the case that the capability information comprises an indication that the device is capable of supporting at least one additional value of the second parameter than the value included in the first message, the second message comprises a value of the second parameter different from the value included in the first message.

24. Apparatus according to claim 22, wherein the processing system is arranged to cause the apparatus to transmit a second message comprising a value of the first parameter associated with the first set of capabilities upon receiving an indication that the device does not support the value of the second parameter.

25. Apparatus according to claim 24, wherein:
the processing system is arranged to cause the apparatus to determine whether the device supports a value of the second parameter associated with the first set of capabilities; and
said second message, which comprises a value of the first parameter associated with the first set of capabilities, comprises a value of the second parameter associated with the first set of capabilities upon determining the device supports said value.

26. Apparatus according to claim 22, wherein the second message comprises one of the value of the second parameter included in the first message and an indication to use the value of the second parameter included in the first message.

27. Apparatus according to claim 22, wherein:
the wireless network is a Long-Term Evolution (LTE) Evolved UTRAN (E-UTRAN);
the apparatus is one of an evolved Node B (eNB) or component of an eNB;
the first message comprises a broadcast System Information (SI) message;
the second message comprises a dedicated signalling message;
the first parameter comprises maximum transmit power (pMax) for a frequency band; and
the second parameter comprises Additional Maximum Power Reduction (A-MPR) for the frequency band.

28. Apparatus according to claim 27, wherein:
the frequency band is Band 13;
the value of the second parameter associated with the first set of capabilities comprises A-MPR NS_{—}07; and
the value of the second parameter associated with the second set of capabilities comprises A-MPR for a portion of Band 13.

29-44. (canceled)
